(19) United States
(12) Patent Application Publication
(10) Pub. No.: US 2012/0233245 A1
(43) Pub. Date: Sep. 13, 2012

(54) VOIP COMMUNICATION SYSTEM AND METHOD FOR REGISTERING CLIENT DEVICES WITH SAME

(75) Inventor: CHIA-HAO LIU, Tu-Cheng (TW)

(73) Assignee: HON HAI PRECISION INDUSTRY CO., LTD., Tu-Cheng (TW)

(21) Appl. No.: 13/171,462

(22) Filed: Jun. 29, 2011

(30) Foreign Application Priority Data
Mar. 9, 2011 (CN) 201110055996.2

(51) Int. Cl. G06F 15/16

(52) U.S. Cl. 709/203

(57) ABSTRACT

A method registers client devices with a primary device using a backup server. The backup server detects whether the primary server is available, and when the primary server is available, the backup server evaluates the registration capacity of the primary server. The backup server further creates a queue of the client devices registered with the backup server according to the backup registration time of the client devices, and notifies the client devices individually or in groups that the primary server is again available.

### BACKGROUND

1. Technical Field

The disclosure generally relates to communication systems, particularly to a communication system which offers Voice over Internet Protocol (VoIP) services and a method for registering client devices with that communication system.

2. Description of Related Art

Data networks, which may include a local area network (LAN), wide area network (WAN), and a global distributed network such as the Internet, may provide telecommunications services, such as a packet-based telecommunications protocol. One type of packet-based telecommunications architecture includes a number of client devices managed by a controller that establishes, maintains, and terminates communication sessions among the different client devices.

To participate in a communication session, client devices typically register themselves with a server (generally a primary server). When the primary server is unavailable (i.e., it is unresponsive or rejects the registration attempts of the client devices) due to equipment malfunction and/or network congestion, the registered client devices have to alternatively register themselves with a backup or secondary server to receive communication services. When the primary server becomes available, the client devices registered with the backup or secondary server should unregister from the backup or secondary server and register themselves back with the primary server instead. When there is a large number of the client devices try to re-establish registration with the primary server simultaneously, the communication system will be overloaded and operate inefficiently.

Therefore, there is room for improvement within the art.

### BRIEF DESCRIPTION OF THE DRAWINGS

Many aspects of the VoIP communication system and a method for registering client devices with same can be better understood with reference to the following drawings. The components in the drawings are not necessarily drawn to scale, the emphasis instead being placed upon clearly illustrating the principles of the VoIP communication system and a method for registering client devices with same.

FIG. 1 is a schematic block diagram of an exemplary VoIP communication system including an exemplary backup server.

FIG. 2 is a schematic block diagram of an exemplary backup server and an exemplary client device.

FIG. 3 is a schematic flowchart of an exemplary method for re-establishing the registration of client devices back with a primary server.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device. Some non-limiting examples of non-transitory computer-readable mediums include DVDs, CDs, and hard disk drives.

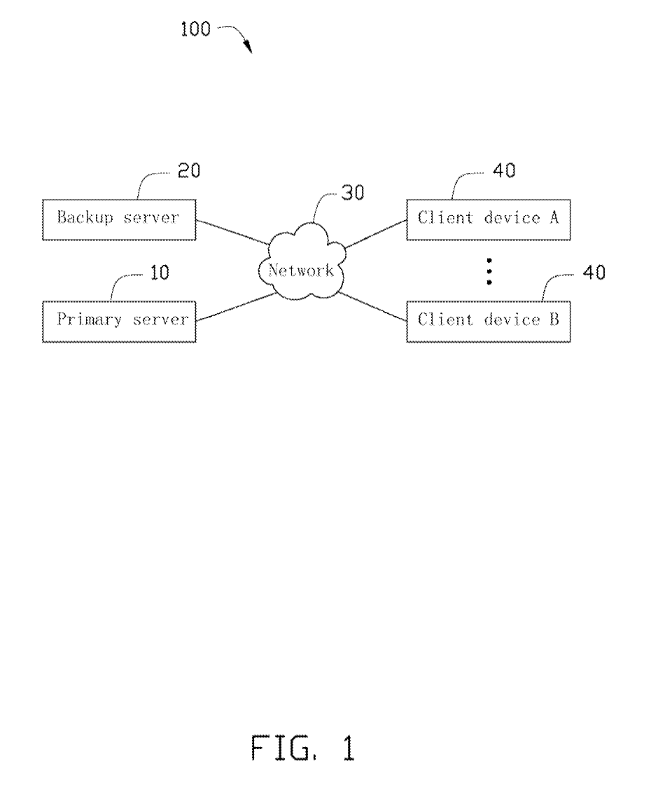

FIG. 1 shows a backup server 20 used in a VoIP communication system 100 which offers VoIP services, according to an exemplary embodiment. The VoIP communication system 100 includes a primary server 10, a backup server 20, a network 30 and a plurality of client devices 40 (e.g. the client device A and the client device B). In general, the primary server 10 receives registration requests from the client devices 40. When the primary server 10 becomes unavailable (i.e., it is non-responsive or it rejects the registration requests of the client devices) due to equipment malfunction and/or network congestion, the client devices 40 registered with the primary server 10 will seek the alternative backup server 20 and attempt to register themselves with it to receive communication services.

Communications between elements of the VoIP communication system 100 are implemented via the network 30. The network 30 represents any suitable collection and arrangement of components for providing communications between various elements. For example, the network 30 can include one or more local area networks (LANs), wide area networks (WANs), elements of the public switched telephone network (PSTN), and portions of a global communications network, such as the Internet. According to an exemplary embodiment, the network 30 supports packet-based communication protocols such as voice over Internet protocol (VOIP) communications sessions involving the client devices 40, with these sessions being managed by the primary sever 10 and the backup server 20.

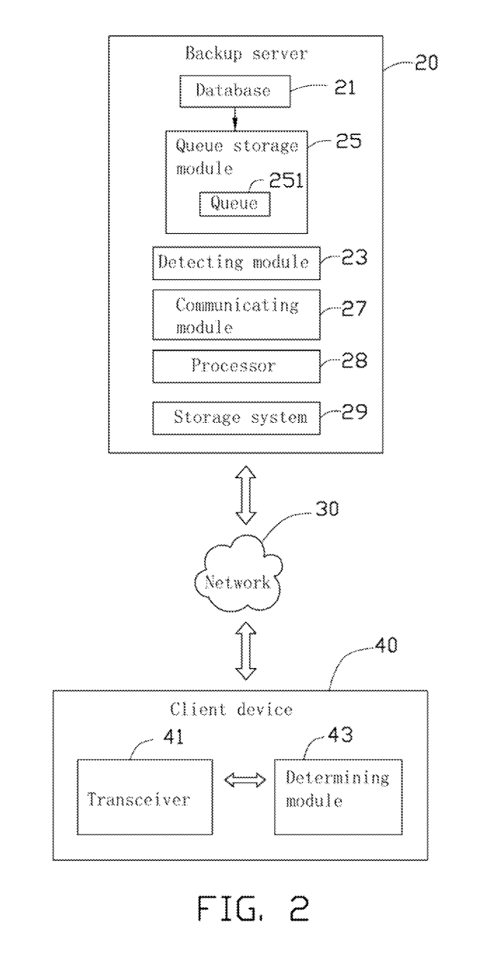

FIG. 2 shows an exemplary backup server 20 which includes a database 21, a detecting module 23, a queue storage module 25 and a communicating module 27. The backup server 20 further includes a processor 28 and a storage system 29. The processor 28 executes one or more computerized operations of the backup server 20 and other applications, to provide the functions of the backup server 20. The storage system 29 stores at least one program, such as an operating system, and other applications of the backup server 20. The database 21 and the queue storage module 25 can be integrated in the storage system 29. The modules 23, 25, and 27 each include at least one computerized codes stored in the storage system 29 to be executed by the processor 28 to perform corresponding operations of the backup server 20. Details of these operations will be provided below.

The database 21 stores information regarding the client devices 40 communicating therewith. The detecting module 23 is used to detect whether the previously unavailable primary server 10 is now available. The primary server 10 has a registration capacity which represents a quantity of the client device 40 can be registered to the primary server 10 at once. For example, the registration capacity of the primary server 10 is ten means the primary server 10 can register ten client devices 40 at once. When the detecting module 23 detects that the primary server 10 is available, the detecting module 23 is further used to evaluate the registration capacity of the primary server 10. The queue storage module 25 has a queue 251 built therein. When the primary server 10 is available, the queue storage module 25 creates the queue 251 to store the client devices 40 stored in the database 21 according to a registration time of the client devices 40 registered with the backup server. Thus, the backup server 20 allows access to the client devices 40 on a first input first output (FIFO) principle, according to the exemplary embodiment.

The communicating module 27 is used to notify the client devices 40 that the primary server is available. The communicating module 27 notifies a number of the client devices 40 according to the registration capacity of the primary server 10. For example, if the queue 251 stores one hundred client devices 40, and the recovery primary server 10 can register ten client devices 40 at once, the communication module 27 will notify the first ten client devices 40 at the front of the queue 251, and then process the remaining client devices 40 in the same way. The number of the client devices 40 which are notified by the communicating module 27 from the queue 251 may be less than or equal to the registration capability of the primary server 10 and never more.

The communicating module 27 is further used to receive feedback information from the client devices 40 to determine whether the client devices 40 have registered themselves back to the primary server 10. If the communicating module 27 determines that one client device 40 has registered itself back with the primary server 10, the queue storage module 25 removes that particular client device 40 from the queue 251. Otherwise, if the communicating module 27 determines that a particular client device 40 cannot be registered with the primary server 10 at present, the queue storage module 25 moves that particular client device 40 from the front to the back of the queue 251.

Each client device 40 includes a transceiver 41 and a determining module 43. The transceiver 41 receives a notification transmitted from the communicating module 27, and transmits the feedback information to the communicating module 27. The determining module 43 is used to determine whether the client device 40 is registered to the primary server 10. If the client device 40 has become registered with the primary server 10, the transceiver 43 transmits a positive feedback information indicating that the device 40 is registered to the primary server 10. Accordingly, the client device 40 deletes the registration to the backup server 20. Otherwise, if the client device 40 is not able to register with the primary server 10 at present for various reasons, such as because the device 40 is in use, the transceiver 41 transmits a negative feedback information indicating that the client device 40 cannot be registered at present with the primary module 10 to the communicating module 27.

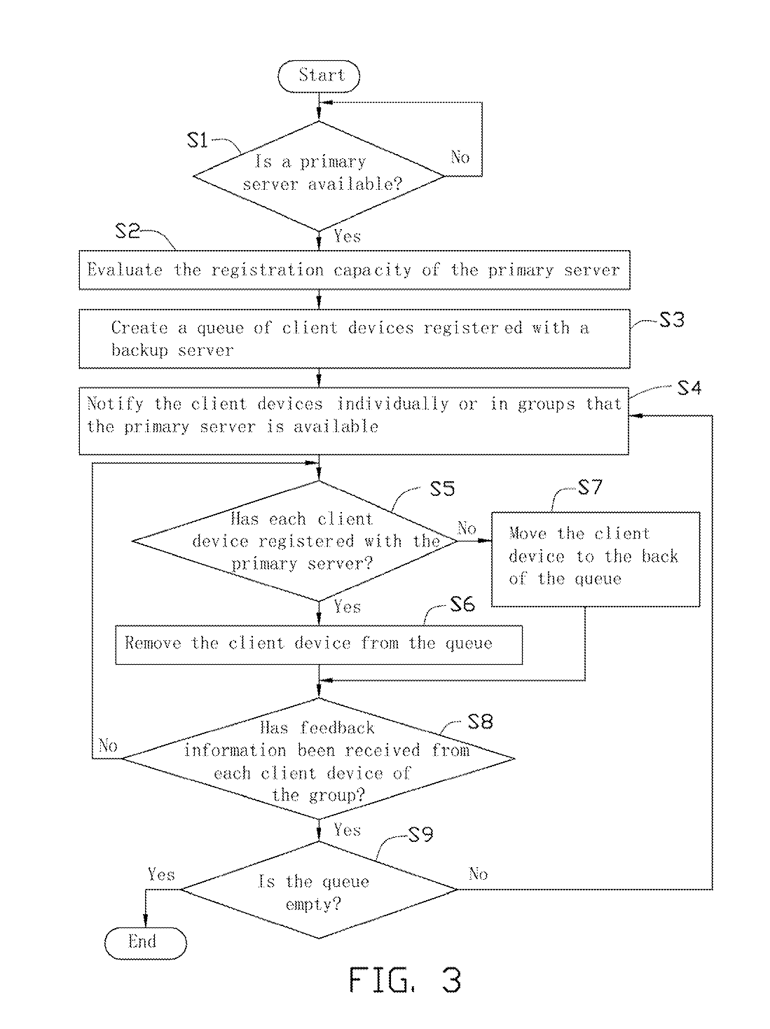

FIG. 3 is a flowchart of re-registering the client devices 40 with a primary server of the VoIP communication system 100 of FIG. 1, according to the exemplary embodiment. Depending on the embodiment, additional blocks may be added, others removed, and the ordering of the blocks may be changed.

Step S1, the detecting module 23 detects whether the primary server 10 is available. If the primary server 10 is available, steps S2-S5 are executed sequentially, otherwise the procedure repeats step S1.

Step S2, the detecting module 23 evaluates the registration capacity of the primary server 10.

Step S3, the queue storage module 25 creates a queue 251 of the client devices 40 registered with the backup server 20 according to the registration time of the client devices 40.

Step S4, the communicating module 27 notifies the client devices 40 individually or in groups that the primary server 10 is available, a number of the client devices 40 may be notified in one group according to the registration capability of the primary server 10 at that time.

Step S5, the communicating module 27 receives the feedback information from one of, or a group of, the client devices 40 and determines whether each client device 40 is registered with the primary server 10 according to that feedback information.

Step S6, if the client device 40 is registered with the primary server 10, the queue storage module 25 removes the client device 40 form the queue 251, and the procedure goes to step S8.

Step S7, if the device 40 cannot be registered with the primary server 10 at that moment in time, the queue storage module 25 moves the client device 40 to the back of the queue 251, and the procedure goes to step S8.

Step S8, the communicating module 27 determines whether the feedback information has been received from each client device 40 of the group. If the communicating module 27 has not received the feedback information from each client device 40, the procedure returns back to step S5.

Step S9, if the communicating module 27 receives the positive feedback information from each client device 40 of the group, the queue storage module 25 determines whether the queue 251 is empty. If a queue still exists, the procedure returns back to the step S4.

It should be emphasized that the described inventive embodiments are merely possible examples of implementations, and are set forth for a clear understanding of the principles of the present disclosure. Many variations and modifications may be made to the above-described inventive embodiments without departing substantially from the spirit and principles of the present disclosure. All such modifications and variations are intended to be comprised herein within the scope of this disclosure and the above-described inventive embodiments, and the present disclosure is protected by the following claims.

What is claimed is:

1. A backup server for registering client devices with a primary server, comprising:
a storage system;
at least one processor; and
at least one modules stored in the storage system and executed by the at least one processor, the at least one modules comprising:
a detecting module operable to detect whether the primary server is available;
a queue storage module including a queue, the queue operable to store the client devices according to a registration time of the client devices registered with the backup server;
a communicating module operable to notify the client devices that the primary server is available.

2. The backup server as claimed in claim 1, wherein the primary server has a registration capacity, the detecting module further operable to evaluate the registration capacity of the primary server, the communicating module notify a number of the client devices according to the registration capacity of the primary server.

3. The backup server as claimed in claim 2, wherein the communicating module is further operable to receive feedback information from the client devices to determine whether the client devices have registered themselves with the primary server, if one client device has registered itself with the recovery primary server, the queue storage module removes the particular client device from the queue.

4. The backup server as claimed in claim 3, wherein the backup server allows access to the devices on a first input first output principle, if the client device cannot be register with the primary at present, the queue storage module moves that particular client device from the front to the back of the queue.

5. The backup server as claimed in claim 1, wherein each client device includes a transceiver which is operable to receive a notification transmitted from the communicating module and transmit the feedback information to the communicating module.

6. The backup server as claimed in claim 5, wherein each client device further includes a determining module which determines whether the client device is registered with the recovery primary server.

7. A method for registering client devices with a primary server using a backup server, comprising:
detecting whether the primary server is available;
evaluating registration capacity of the primary when the primary server is available;
creating a queue of the client devices that are registered with the backup server according to the registration time of the client devices;
notifying the client devices individually or in groups that the primary server is available.

8. The method as claimed in claim 7, wherein a number of the client devices in one group is according to the registration capacity of the primary server.

9. The method as claimed in claim 7, further comprising:
receiving a feedback information from one of or a group of the client devices and determining whether each client device is registered with the primary server according to the feedback information, if the client device is registered with the primary server, removing the client device from the queue.

10. The method as claimed in claim 7, wherein the backup server allows access to the devices on a first input first output principle, if the client device cannot be register with the primary server, moving the client device from the front to the back of the queue, until all client devices is registered with the available primary server.

11. A non-transitory storage medium storing a set of instructions, the set of instructions capable of being executed by a processor to perform a method for registering client devices to a primary server with a backup server, comprising:
detecting whether the primary server is available;
evaluating registration capacity of the primary when the primary server is available;
creating a queue of the client devices registered with the backup server according to the registration time of the client devices;
notifying the client devices individually or in group that the primary server is available.

12. The non-transitory storage medium as claimed in claim 11, wherein a number of the client devices in one group is according to the registration capacity of the primary server.

13. The non-transitory storage medium as claimed in claim 11, further comprising:
receiving a feedback information from one of or a group of the client devices and determining whether each client device is registered with the primary server according to the feedback information, if the client device is registered with the primary server, removing the client device from the queue.

14. The non-transitory storage medium as claimed in claim 11, the backup server allows access to the devices on a first input first output principle, if the client device cannot be register with the primary server, moving the client device from the front to the back of the queue, until all client devices is registered with the available primary server.
